(19) United States
(12) Patent Application Publication
(10) Pub. No.: US 2013/0289755 A1
(43) Pub. Date: Oct. 31, 2013

(54) PLAYER DEVICE AND METHOD FOR PROCESSING MEDIA CONTENT USING THE PLAYER DEVICE

(71) Applicant: Yung-Sheng LIU, Tu-Cheng (TW)

(72) Inventor: Yung-Sheng LIU, Tu-Cheng (TW)

(73) Assignee: HON HAI PRECISION INDUSTRY CO., LTD., Tu-Cheng (TW)

(21) Appl. No.: 13/600,226

(22) Filed: Aug. 31, 2012

(30) Foreign Application Priority Data
Apr. 27, 2012 (TW) 101115064

(51) Int. Cl. G06F 17/00

(52) U.S. Cl. 700/94

(57) ABSTRACT

In a method for processing media content using a player device, a program-specific information (PSI) table and a specific date of the media content are read and stored into a register of a controller in the player device. A date difference between a current date from a real-time clock chip and the specific date of the media content is calculated. The method further controls the controller of the player device to play the media content from the storage device according to the PSI table. When playing time of the one or more voice files is arrived, the method further controls the controller to play the one or more voice files corresponding to the calculated date difference.

### BACKGROUND

1. Technical Field

Embodiments of the present disclosure relate to media content, and more particularly to a player device, a storage medium, and a method for processing media content using the player device.

2. Description of Related Art

Media content that discuss about festivals or history programs can be monotonous for users. For example, if the media content is about Christmas is played for children, only date of the Christmas (e.g., Dec. 25) may be introduced to the children. However, the children may not have a concept of time and may not know how many days there are to Christmas. If the media content about a history story is played for an audience, only the time of occurrence of the history (e.g., 1900 AD) is introduced, and the audience may have no conception of the time from the occurrence time to today. Furthermore, the media content is unchangeable even when it is played on different dates. Therefore, users may not have any sense of the distance of time and may have no expectations as to the media content when the media content is played on different dates.

### BRIEF DESCRIPTION OF THE DRAWINGS

FIG. 1 is a block diagram of one embodiment of a player device including a media processing system.

FIG. 2 is a block diagram of function modules of the media processing system included in the player device of FIG. 1.

FIG. 3 is a flowchart of one embodiment of a method for processing media content using the player device of FIG. 1.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module” as used herein refers to logic embodied in hardware or firmware, or to a collection of software instructions, written in a programming language, such as, Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media include compact discs (CDs), digital versatile discs (DVDs), Blu-ray disks, flash memory, and hard disk drives.

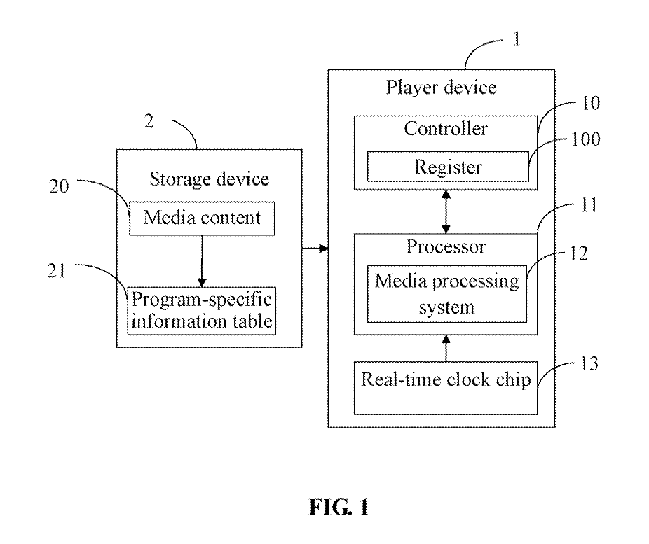

FIG. 1 is a block diagram of one embodiment of a player device 1 including a media processing system 12. The player device 1 further includes a controller 10, at least one processor 11, and a real-time clock (RTC) chip 13. The controller 10 may control the player device 1 to play media content 20 stored in a storage device 2. The controller 10 includes a register 100 that temporarily stores data of the controller 10. In one embodiment, the controller 10 may be a Moving Pictures Experts Group (MPEG) controller. The RTC chip 13 tracks and outputs a current date including year, month, and day. The media content 20 is a specific program that includes an audio and video file. The specific program may be a festival program or a history program, for example. The media content 20, in one embodiment, presets a specific date of the specific program. The media processing system 12 may also preset a plurality of voice files for the media content 20, and play one or more the voice files according to a date difference between a current date and the specific date of the media content 20.

The storage device 2 may be a digital versatile disc (DVD) that stores the media content 20. The storage device 2 further stores the specific date of the media content 20. In one embodiment, the specific date of the media content 20 is preset according to the festival date or history period of the media content 20. If the media content 20 is a media file about the festival program (e.g., Christmas), a format of the specific date is “month-day”. If the media content 20 is about the history program, the format of the specific date is “year”.

In one embodiment, the media content 20 includes a plurality of audio files, at least one video file, and a plurality of voice files preset for the media content 20. If the media content 20 is about the festival program, the plurality of voice files are preset according to a number of days' difference between a current day and the specific date. For example, if the media content 20 is about Christmas, a voice file corresponding to a day difference of one day may be voice of “tomorrow is Christmas”. A voice file corresponding to a day difference of two days may be voice of “Two days later is Christmas”. A voice file corresponding to a day difference of between three days and thirty days may be voice of “Christmas is coming soon a few days later”. The content of the voice files can be preset according to user requirements.

If the media content 20 is about the history program, the plurality of voice files includes one or more formatted voice files and number-voice files. The formatted voice files are preset according to the history program. The number-voice files may include digits and numbers given orally, the numbers 0 to 9, ten, hundred, thousand, and million. The number-voice files corresponds to a number of years' difference between a current year and the specific date of the media content 20. There is a preset order among the formatted voice files and number-voice files. For example, if the media content 20 introduces a content of “a first battle took place in 1911”, then the plurality of voice files may include a first formatted voice of “a first battle took place”, a second formatted voice of “ago from today in 1911”, and number-voice files corresponding to the number of years before today since the year 1911.

The order of the plurality of the voice files are the first formatted voice file, the number-voice files, and the second formatted voice file.

The storage device 2 further includes a program-specific information (PSI) table 21 that records information of the media content 20. In the embodiment, the PSI table 21 records playing time of each of the audio files, the video files and the one or more voice files. The one or more voice files are confirmed according to the media content 20 and the date difference (e.g. the number of days difference or number of years difference) between the current date and the specific date. The PSI table 21 may include a program association table (PAT), a program map table (PMT) and other information of the media content 20. By reference to the PSI table 21, the player device 1 can find the audio files, the video files and the one or more voice files easily to be played at the corresponding recorded playing time. The at least one processor 40 executes one or more computerized codes and other applications of the player device 1, to provide functions of the media processing system 12.

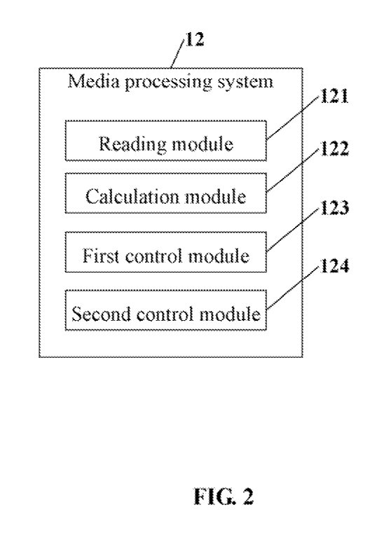

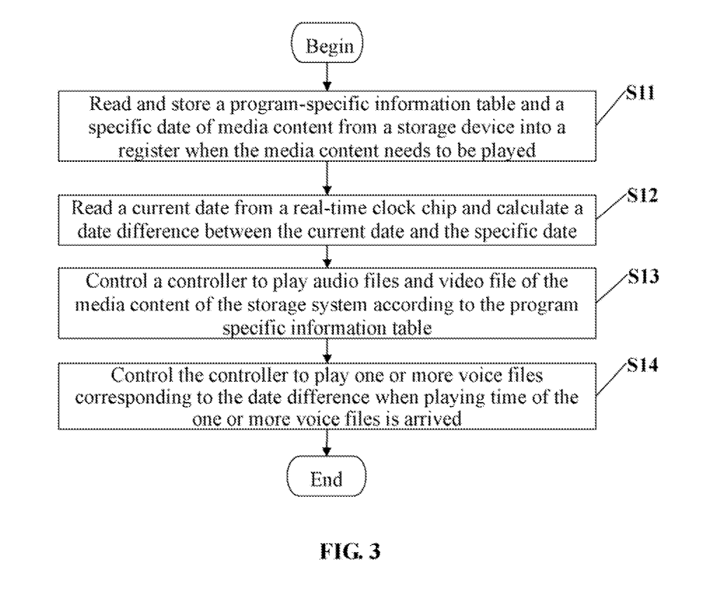

FIG. 2 is a block diagram of function modules of the media processing system 12 included in the player device 1 of FIG. 1. In the embodiment, the media processing system 12 may include a reading module 121, a calculation module 122, a first control module 123, and a second control module 124. The modules 121-124 comprise computerized codes in the form of one or more programs that are stored in a memory system of the player device 1. The computerized codes include instructions that are executed by the at least one processor 11 to provide functions for the modules. Details of each of the modules will be given in FIG. 3.

FIG. 3 is a flowchart of one embodiment of a method for processing media content using the player device 1 of FIG. 1. Depending on the embodiment, additional steps may be added, others deleted, and the ordering of the steps may be changed.

In step S11, when the media content 20 in the storage device 2 needs to be played by the player device 1, the reading module 121 reads the PSI table 21 and the specific date of the media content 20 from the storage device 2, and stores the PSI table 21 and the specific date of the media content 20 into the register 100.

In step S12, the calculation module 122 reads a current date from the RTC chip 13 through the processor 11, and calculates a date difference between the current date and the specific date of the media content 20. If the format of the specific date is “month-day”, the date difference is represented by a number of days. If the format of the specific date is “year”, the date difference is represented by a number of years.

In step S13, the first control module 123 controls the controller 10 to read audio files and video files of the media content 20 for playing the media content 20, according to the PST table 21 in the register 11. In one embodiment, the controller 10 finds playing times recorded in the PST table 21, and plays the audio files and the video files during the playing time.

In step S14, when the playing time of one voice file is arrived, the second control module 124 controls the controller 10 to read and play the voice file corresponding to the calculated date difference in the storage device 2. For example, if the date difference is one day, the second control module 124 reads the voice file of “tomorrow is the Christmas” corresponding to the date difference of one day. If the date difference is represented by a number of years, the second control module 124 controls the controller 10 to play the formatted voice files and number-voice files corresponding to the date difference of the years, according to the preset order among the formatted voice files and the number-voice files. As in the above-mentioned example in paragraph [0011] , if the date difference is “101” years, the controller 10 may firstly play the first formatted voice of “a first battle took place”, then play the number-voice files corresponding to the number of “101”, and then play the second formatted voice of “years ago from today in 1911”. In one embodiment, after the controller 10 finishes the play of the voice files, the controller 10 continues to play the audio files and the video files of the media content 20 according to the PSI table 21.

All of the processes described above may be embodied in, and be fully automated via, functional code modules executed by one or more general-purpose processors. The code modules may be stored in any type of non-transitory computer readable medium or other storage device. Some or all of the methods may alternatively be embodied in specialized hardware. Depending on the embodiment, the non-transitory computer readable medium may be a hard disk drive, a compact disc, a digital video disc, a tape drive or other suitable storage medium.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure, are protected by the following claims.

What is claimed is:

1. A method of a player device, the player device in communication with a storage device that stores media content, the method comprising:
reading a program-specific information (PSI) table and a specific date of the media content from the storage device, and storing the PSI table and the specific date of the media content into a register of a controller in the player device, the PSI table recording playing time of one or more voice files of the media content;
reading a current date from a real-time clock chip in the player device, and calculating a date difference between the current date and the specific date of the media content;
controlling the controller to play the media content of the storage device according to the PSI table; and
controlling the controller to play the one or more voice files corresponding to the calculated date difference when the playing time of the one or more voice files is arrived.

2. The method according to claim 1, wherein the media content is a festival program or a history program including an audio and video file, and comprises a plurality of audio files, at least one video file, and a plurality of voice files preset for the media content.

3. The method according to claim 2, wherein the specific date of the media content is a month-day format and each of the voice files is preset according to a number of days' difference between a current day and the specific date, if the media content is about the festival program, or the specific date is a year format and the plurality of voice files comprises one or more formatted voice files and number-voice files if the media content is about the history program.

4. The method according to claim 3, wherein the formatted voice files are preset according to the history program and the number-voice files comprising voices of number 0 to 9, ten, hundred, thousand, and million that are preset according to a number of years' difference between a current year and the specific date.

5. The method according to claim 3, further comprising:
controlling the controller to play the voice file corresponding the date difference of the days, if the date difference is represented by a number of days; or
controlling the controller to play the one or formatted voice files and number-voice files corresponding to the date difference of the years according to a preset order among the formatted voice files and the number-voice files, if the date difference is represented by a number of years.

6. The method according to claim 2, wherein the PSI table further records playing time of each of the audio files, video files of the media content, and the media content is played by playing the audio files, the video files and the one or more voice files at the playing time recorded in the PSI table.

7. A non-transitory storage medium storing a set of instructions, when executed by at least one processor of a player device, causes the player device to perform a method for processing media content, the player device in communication with a storage device that stores the media content, the method comprising:
reading a program-specific information (PSI) table and a specific date of the media content from the storage device, and storing the PSI table and the specific date of the media content into a register of a controller in the player device, the PSI table recording playing time of one or more voice files of the media content;
reading a current date from a real-time clock chip in the player device, and calculating a date difference between the current date and the specific date of the media content;
controlling the controller to play the media content of the storage device according to the PSI table; and
controlling the controller to play the one or more voice files corresponding to the calculated date difference when the playing time of the one or more voice files is arrived.

8. The non-transitory storage medium according to claim 7, wherein the media content is a festival program or a history program including an audio and video file, and comprises a plurality of audio files, at least one video file, and a plurality of voice files preset for the media content.

9. The non-transitory storage medium according to claim 8, wherein the specific date of the media content is a month-day format and each of the voice files is preset according to a number of days' difference between a current day and the specific date, if the media content is about the festival program, or the specific date is a year format and the plurality of voice files comprises one or more formatted voice files and number-voice files if the media content is about the history program.

10. The non-transitory storage medium according to claim 9, wherein the formatted voice files are preset according to the history program and the number-voice files comprising voices of number 0 to 9, ten, hundred, thousand, and million that are preset according to according to a number of years' difference between a current year and the specific date.

11. The non-transitory storage medium according to claim 11, further comprising:
controlling the controller to play the voice file corresponding the date difference of the days, if the date difference is represented by a number of days; or
controlling the controller to play the one or formatted voice files and number-voice files corresponding to the date difference of the years according to a preset order among the formatted voice files and the number-voice files, if the date difference is represented by a number of years.

12. The non-transitory storage medium according to claim 8, wherein the PSI table further records playing time of each of the audio files, video files of the media content, and the media content is played by playing the audio files, the video files and the one or more voice files at the playing time recorded in the PSI table.

13. A player device in communication with a storage device that stores media content, the player device comprising:
a controller;
a real-time clock chip;
at least one processor; and
one or more programs that are executed by the at least one processor, the one or more programs comprising:
a reading module that reads a program-specific information (PSI) table and a specific date of the media content from the storage device and storing the PSI table and the specific date of the media content into a register of the controller, the PSI table recording playing time of one or more voice files of the media content;
a calculation module that reads a current date from a real-time clock chip in the player device, and calculates a date difference between the current date and the specific date of the media content in the register;
a first control module that controls the controller of the player device to play the media content of the storage device according to the PSI table; and
a second control module that controls the controller to play the one or more voice files corresponding to the calculated date difference, when the playing time of the one or more voice files is arrived.

14. The player device according to claim 13, wherein the media content is a festival program or a history program including an audio and video file, and comprises a plurality of audio files, at least one video file, and a plurality of voice files preset for the media content.

15. The player device according to claim 14, wherein the specific date of the media content is a month-day format and each of the voice files is preset according to a number of days' difference between a current day and the specific date, if the media content is about the festival program, or the specific date is a year format and the plurality of voice files comprises one or more formatted voice files and number-voice files if the media content is about the history program.

16. The player device according to claim 15, wherein the formatted voice files are preset according to the history program and the number-voice files comprising voices of number 0 to 9, ten, hundred, thousand, and million that are preset according to according to a number of years' difference between a current year and the specific date.

17. The player device according to claim 14, wherein the first control module controls the controller to play the voice file corresponding the date difference of the days, if the date difference is represented by a number of days; or controls the controller to play the one or formatted voice files and number-voice files corresponding to the date difference of the years according to a preset order among the formatted voice files and the number-voice files, if the date difference is represented by a number of years.

18. The player device according to claim 14, wherein the PSI table further records playing time of each of the audio files, video files of the media content, and the media content is played by playing the audio files, the video files and the one or more voice files at the playing time recorded in the PSI table.
